(19) United States
(12) Patent Application Publication
(10) Pub. No.: US 2013/0017381 A1
(43) Pub. Date: Jan. 17, 2013

(54) SODIUM ACCUMULATION LAYER FOR ELECTRONIC DEVICES

(71) Applicants: Keith J. Burrows, Mineral Point, WI (US); Harshad P. Patil, Spring Green, WI (US); Annette J. Krisko, Sauk City, WI (US)

(72) Inventors: Keith J. Burrows, Mineral Point, WI (US); Harshad P. Patil, Spring Green, WI (US); Annette J. Krisko, Sauk City, WI (US)

(73) Assignee: CARDINAL CG COMPANY, Eden Prairie, MN (US)

(21) Appl. No.: 13/180,992

(22) Filed: Jul. 12, 2011

(51) Int. Cl. B32B 7/02; B32B 9/04; B32B 15/04

(52) U.S. Cl. 428/216; 428/333

(57) ABSTRACT

A coated substrate useful as a transparent electrode for electrical or optical devices is provided. The coated substrate includes a transparent sodium-containing substrate with a protective layer disposed over the transparent sodium-containing substrate. Characteristically, the protective layer has a thickness of at least 400 angstroms and comprises aluminum oxides and silicon oxides. An electrically conductive layer is disposed over the protective layer. In other variations, devices incorporating such coated substrates are provided.

### FIELD OF THE INVENTION

In at least one aspect, the present invention relates to structures and methods for reducing the deleterious effects of sodium in semiconductor devices such as photovoltaic cells.

### BACKGROUND OF THE INVENTION

A number of multilayer electro-optical devices include electronically active layers that that are deposited on glass substrates. In many of these applications, soda lime glass is used because of its availability and low cost. Although low sodium glasses such as borosilicate glass, are available, the utilization of such glasses are limited due to their relatively high cost and suboptimal physical properties (e.g., low thermal coefficient of expansion).

Types of soda lime glass include flat glass and container glass. Flat glass is most typically used as a substrate for multilayer electro-optical devices. Such flat glass is usually formed by a float process in which ingredients such as silicon dioxide, sodium carbonate (soda), lime, dolomite, aluminum oxide, and fining agents are melted in a furnace. For photovoltaic applications, low iron and mid iron float glasses are typically used because of their higher transmission. Soda lime glasses are characterized by having significant levels of sodium which is formally represented as Na₂O in the glass composition. Na₂O is typically present in an amount of 12 to 15 weight percent.

In an electro-optical device such as photovoltaic devices, transparent conductors are coated onto a glass substrate, over which multilayer electronically active are deposited. Examples of photovoltaic active layers include amorphous silicon, cadmium telluride, copper indium gallium selenide, and the like. Sodium from the glass substrate is known to diffuse from the substrate into the active layer thereby degrading performance of such devices. It is well known that the deleterious effects of sodium can be mitigated by the incorporation of a sodium barrier over the glass substrate prior to application of the electronically active layers. The sodium barrier is characterized by having a very low diffusion coefficient with respect to sodium. Examples of sodium barriers that that have been successfully utilized include silicon oxide and aluminum oxide. In generally, these protective layers are amorphous in character in order to minimize diffusion of sodium along grain boundaries.

Although the sodium barrier layers have been successfully used in many applications, unsatisfactory performance has been observed for certain applications. For example, delamination at the sodium barrier layer has plagued a number of devices. Such delamination is believed to be caused by accumulation of sodium at the sodium barrier layer/glass interface. Migration of sodium may be the result of heating during deposition of the transparent electrode, heating during deposition of the photovoltaic (PV) absorber, or to elevated temperatures present during operation of devices incorporating the transparent electrode. Sodium migration may also occur due to electrical bias in field arrays.

Accordingly, there is a need for improved methods of reducing the deleterious effects of sodium in electro-optical devices.

### SUMMARY OF THE INVENTION

In at least one embodiment, the present invention solves one or more problems of the prior art by providing a coated substrate for electrical or optical devices. The coated substrate includes a transparent sodium-containing substrate with a protective layer disposed over the transparent sodium-containing substrate. Characteristically, the protective layer has a thickness of at least 300 angstroms and comprises aluminum oxides and silicon oxides. An electrically conductive layer is disposed over the protective layer.

In another embodiment, a coated substrate for electrical or optical devices is provided. The coated substrate includes a transparent sodium containing substrate and a protective layer disposed over the substrate. The protective layer has a thickness of from about 300 to about 2000 angstroms and comprises sodium, aluminum oxides and silicon oxides. An electrically conductive layer is disposed over the protective layer.

In still another embodiment, a device having a sodium accumulation layer is provided. The device includes a coated substrate and at least one electrically active layer disposed over the coated substrate. The coated substrate includes a transparent sodium containing substrate and a protective layer disposed over the substrate. The protective layer has a thickness from about 300 to 2000 angstroms and comprises aluminum oxides and silicon oxides. An electrically conductive layer disposed over the protective layer.

In yet another embodiment, a method of forming the coated substrates set forth above is provided. The method comprises a step of sputter coating a protective layer over a transparent sodium containing substrate. The protective layer has a thickness of at least 300 angstroms and comprises sodium, aluminum oxides and silicon oxides. Optionally sputtering coating a sodium barrier over the protective layer. An electrically conductive layer is then sputtering coated over the protective layer to form the coated substrate. The coated substrate is then heat treated or tempered.

It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

FIG. 1 provides a schematic cross section of a coated substrate that includes a sodium accumulation layer;

FIG. 2 provides a schematic cross section of a coated substrate that includes a sodium accumulation layer;

FIG. 3 provides a schematic cross section of a coated substrate that includes a sodium accumulation layer;

FIG. 4 provides a schematic cross section of an electro-optical device that includes a coated substrate with a sodium accumulation layer;

FIG. 5 provides a schematic cross section of a coated substrate that includes a sodium accumulation layer and a high index layer;

FIG. 6 provides a schematic illustration of a system for making the coated substrates of FIGS. 1-3 and 5;

FIG. 7 provides an XPS plot for a glass substrate coated with a single aluminum zinc oxide (AZO) layer;

FIG. 8 provides an XPS plot for a glass substrate coated with a tin oxide and then an AZO layer;

FIG. 9 provides an XPS plot for a glass substrate coated with a silicon oxide/aluminum oxide layer and then an AZO layer; and

FIG. 10 provides an XPS plot for a glass substrate coated with a tin oxide layer, a silicon oxide/aluminum oxide layer and then an AZO layer.

### DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

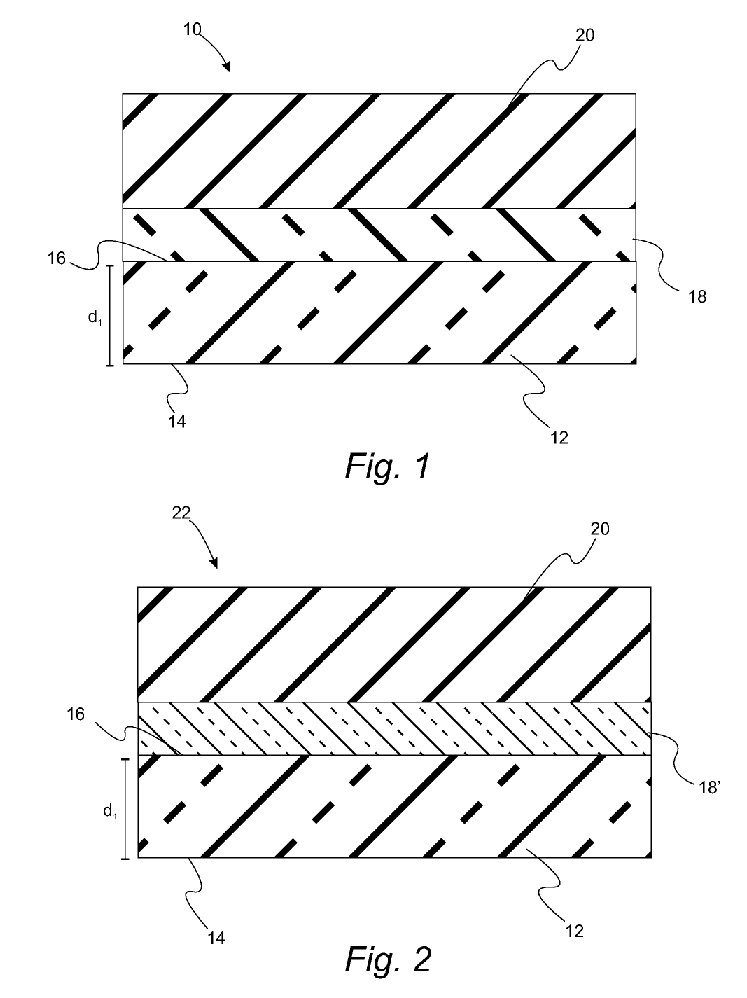

With reference to FIG. 1, a schematic cross section of a coated substrate for electrical or optical devices is provided. Coated substrate 10 includes transparent sodium-containing substrate 12. Typically, sodium-containing substrate 12 is a plate having face 14 and face 16. Substrate 12 is characterized by thickness d₁. In a refinement, protective layer 14 is disposed over transparent sodium-containing substrate 12 and in particular over face 16 of substrate 12. In a refinement, protective layer 18 contacts transparent sodium-containing substrate 12. Protective layer 18 comprises aluminum oxides and silicon oxides. Characteristically, protective layer 18 has a thickness of at least 300 angstroms. In refinement, protective layer 18 has a thickness of at least 350 angstroms. In another refinement, protective layer 18 has a thickness of at least 400 angstroms. Electrically conductive layer 20 is disposed over protective layer 18 and typically contacts protective layer 18.

Protective layer 18 is typically a combination of aluminum oxides and silicon oxides in an amorphous state. Moreover, variations of the present embodiment include a wide range of stoichiometries. In particular, protective layer 18 includes from about 2 to about 50 weight percent aluminum oxides and about 98 to about 50 percent silicon oxides. In a refinement, protective layer 18 includes from about 5 to about 30 weight percent aluminum oxides and about 95 to about 70 weight percent silicon oxides. Moreover, protective layer 18 is characterized having a degree of porosity. In a another refinement, protective layer 18 includes from about 10 to about 25 weight percent aluminum oxides and about 90 to about 75 weight percent silicon oxides 17% aluminum in target 15% aluminum oxide. The combination of aluminum and silicon oxide may be formally represented by the following formula:

SiAlₓO_{y}

wherein x is from 0.01 to 0.6 and y is 2.01 to 2.85. In another refinement, x is from 0.02 to 0.6 and y is 2.01 to 2.7. In still another refinement, x is from 0.05 to 0.4 and y is 2.1 to 2.5.

Electrically conductive layer 20 will typically be a transparent electrically conductive layer. In particular, electrically conductive layer 20 is transparent at visible wavelengths of light. In one refinement, electrically conductive layer 20 has an average visible transmission that is greater than 60% (i.e., the percent of the incident light that is transmitted through electrically conductive layer 16.) In another refinement, electrically conductive layer 16 has an average visible transmission that is greater than 70%. In still another refinement, electrically conductive layer 16 has an average visible transmission that is greater than 85%. Typically, electrically conductive layer 20 has visible transmission less than about 96%. In many applications, electrically conductive layer 20 has visible transmission less than about 90%. In generally, electrically conductive layer 20 has an electrical resistivity less than about 10⁻² ohm-cm. In some refinements, electrically conductive layer 20 has an electrical resistivity from about 10⁻⁵ ohm-cm to about 10⁻² ohm-cm. In other refinements, electrically conductive layer 20 has an electrical resistivity from about 10⁻⁴ ohm-cm to about 10⁻³ ohm-cm.

Particularly useful materials for electrically conductive layer 20 are transparent conducting oxides (TCO). Examples of useful transparent conducting oxides, include but are not limited to tin oxide, doped tin oxide, indium tin oxide, cadmium stannate, zinc oxide, doped zinc oxide, and combination thereof. Zinc oxide is advantageously doped with boron, aluminum, fluorine, and combinations thereof. Tin oxide is advantageously doped with antimony, fluorine, and combinations thereof. Indium oxide is advantageously doped with tin, fluorine, or combinations thereof. Typically, useful transparent conducting oxides layers are of a sufficient thickness to provide a sheet resistance from about 2 ohms-square to about 30 ohms-square. Transparent conductive oxide achieves the requisite sheet resistances at thicknesses between 2000 and 10,000 angstroms.

In another refinement, electrically conductive layer 20 is a metal. Examples of metals that are useful for electrically conductive layer 16 include, but are not limited to, aluminum, silver, stainless steel, molybdenum, copper, and combination thereof.

As set forth above, protective layer 18 has a thickness of at least 300 angstroms. This specified thickness minimum is necessary in order for the protective layer to have sufficient mass and or extent for the protective layer to accumulate sufficient sodium in order to avoid the deleterious effects of sodium in electrically active layer. In a refinement, protective layer 18 has a thickness from about 300 to 2000 angstroms. In another refinement, protective layer 18 has a thickness from about 350 to 2000 angstroms. In yet another refinement, protective layer 18 has a thickness from about 400 to 2000 angstroms. In still another refinement, protective layer 18 has a thickness from about 600 to 2000 angstroms.

With reference to FIG. 2, a schematic cross section of a coated substrate for electrical or optical devices is provided. Coated substrate 22 includes transparent sodium-containing substrate 12. Typically, sodium-containing substrate 12 is a plate having face 14 and face 16. Protective layer 18 is disposed over sodium-containing substrate 12. Protective layer 18 comprises sodium, aluminum oxides and silicon oxides. Characteristically, protective layer 18 has a thickness 400 to about 2000 angstroms. Electrically conductive layer 20 is disposed over protective layer 30 and typically contacts protective layer 18.

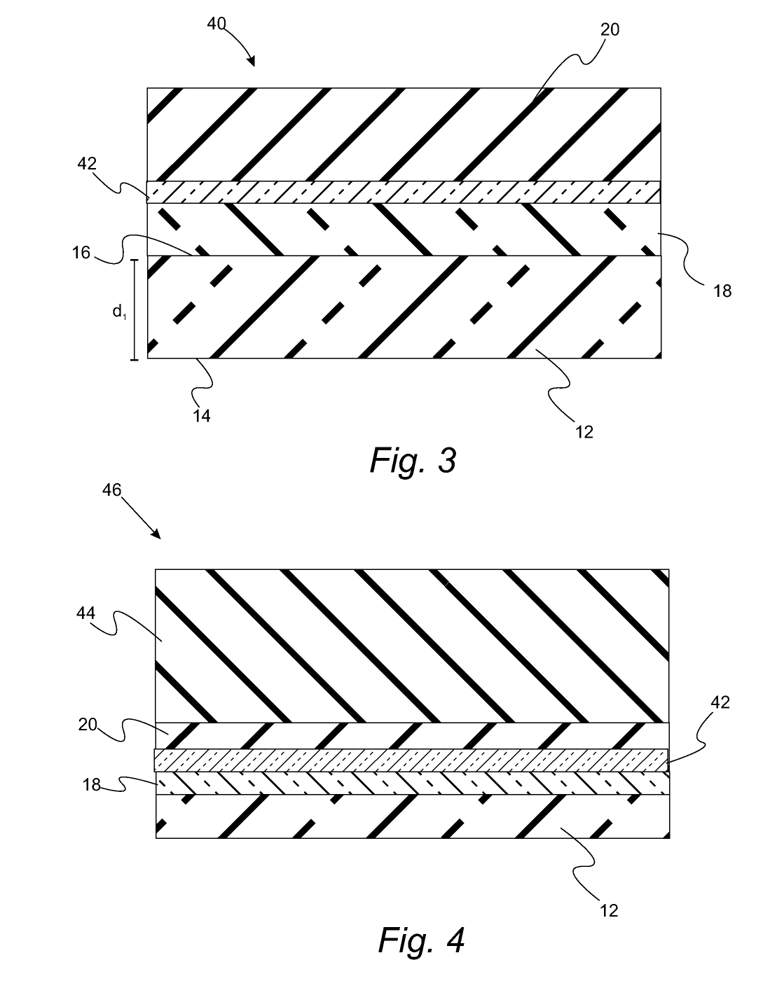

With reference to FIG. 3, a schematic cross section of a coated substrate for electrical or optical devices is provided. Coated substrate 40 includes transparent sodium-containing substrate 12. Typically, sodium-containing substrate 12 is a plate having face 14 and face 16. Substrate 12 is characterized by thickness d₁ which is typically from 1/16 inches to ¼ inches. In a refinement, protective layer 18 is disposed over transparent sodium-containing substrate 12 and in particular over face 16 of substrate 12. In a refinement, protective layer 18 contacts transparent sodium-containing substrate 12. Protective layer 18 comprises aluminum oxides and silicon oxides. Characteristically, protective layer 14 has a thickness of at least 400 angstroms. Sodium barrier layer 42 is disposed over and typically contacts protective layer 18. Finally, electrically conductive layer 20 is disposed over sodium barrier layer 42 and typically contacts sodium barrier layer 42.

With reference to FIG. 4, a device including a coated substrate is provided. Device 46 includes coated substrate 10, 22, or 40, the details of which are set forth above in FIGS. 1, 2, and 3 and the associated descriptions. Coated substrate 10, 22, or 40 includes transparent sodium containing substrate 12. Protective layer 18 is disposed over and typically contacts substrate 12. Protective layer 18 a mixed oxide of aluminum oxides and silicon oxides and having a thickness of at least 400 angstroms. In a refinement, protective layer 18 has a thickness from about 400 to 2000 angstroms. In another refinement, protective layer 18 has a thickness from about 400 to 2000 angstroms. An electrically conductive layer 20 is disposed over the protective layer 18. Electrically active layer(s) 44 is disposed over the coated substrate. Optionally, sodium barrier 42 is interposed between electrically conductive layer 20 and electrically active layer(s) 44.

Still referring to FIG. 4, in one variation of the present embodiment, the electrically active(s) layers comprise amorphous silicon. In a refinement of this variation, device 46 is an amorphous silicon photovoltaic device. In a further refinement, the photovoltaic devices are of a PIN or NIP design, or variations thereof. In another variation, electrically active layer(s) comprises CdTe. In a refinement of this variation, device 46 is a CdTe photovoltaic device.

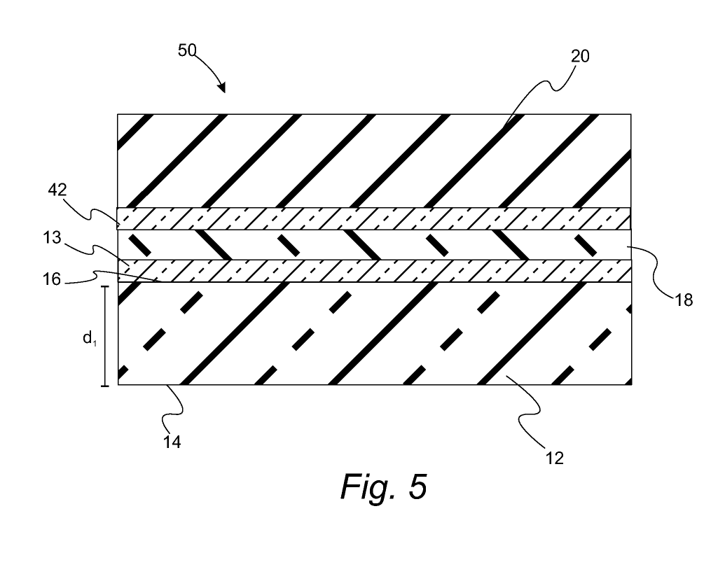

With reference to FIG. 5, a schematic cross section of another embodiment of a coated substrate for electrical or optical devices is provided. Coated substrate 50 includes transparent sodium-containing substrate 12. Typically, sodium-containing substrate 12 is a plate having face 14 and face 16. Substrate 12 is characterized by thickness d₁ which is typically from 1/16 inches to ¼ inches. High index layer 13 is disposed over transparent sodium-containing substrate 12 while protective layer 18 is disposed over high index layer 13. High index layer 13 has a thickness such that this layer does not function as a sodium barrier. To this end, high index layer 13 typically has a thickness less than or equal to 200 angstroms. In a refinement, high index layer 13 has a thickness less than or equal to 150 angstroms. Moreover, high index layer 13 has a refractive index (e.g., about 1.7 to 2.1) that is higher than the refractive index of protective layer 14 (e.g., about 1.6 to 1.7). In a refinement, high index layer 13 contacts transparent sodium-containing substrate 12. Protective layer 18 is disposed over and typically contacts high index layer 13. Protective layer 18 comprises aluminum oxides and silicon oxides and has a thickness of at least 300 angstroms as set forth above. Advantageously, the combination of high index layer 13 and protective layer 18 operates as an antireflection layer. Optionally, sodium barrier layer 42 is disposed over and typically contacts protective layer 14. Finally, electrically conductive layer 20 is disposed over protective layer 14 and typically contacts protective layer 18 is sodium barrier layer 42 is absent.

In another embodiment, a method of forming a coated substrate is provided. The method of the present embodiment is used to form the coated substrates set forth above in connection with FIGS. 1-3 and 5. The method comprises a step of sputter coating protective layer 18 over transparent sodium-containing substrate 12. Protective layer 18 has a thickness of at least 400 angstroms and comprises sodium, aluminum oxides and silicon oxides as set forth above. In a refinement, protective layer 18 has a thickness from about 400 to 2000 angstroms. In another refinement, protective layer 18 has a thickness from about 400 to 2000 angstroms. Optionally, sodium barrier 42 is sputter coated onto protective layer 18. Electrically conductive layer 20 is then sputtered coated over the protective layer to form the coated substrate. In a variation, the coated substrate is then heat treated or tempered such that sodium atoms migrate from sodium-containing substrate 12. It should be appreciated that migration of sodium may occur due to heating during deposition of the transparent electrode, heating during deposition of the PV absorber, or to elevated temperatures present during operation of devices incorporating the transparent electrode. Sodium migration may also occur due to electrical bias in field arrays.

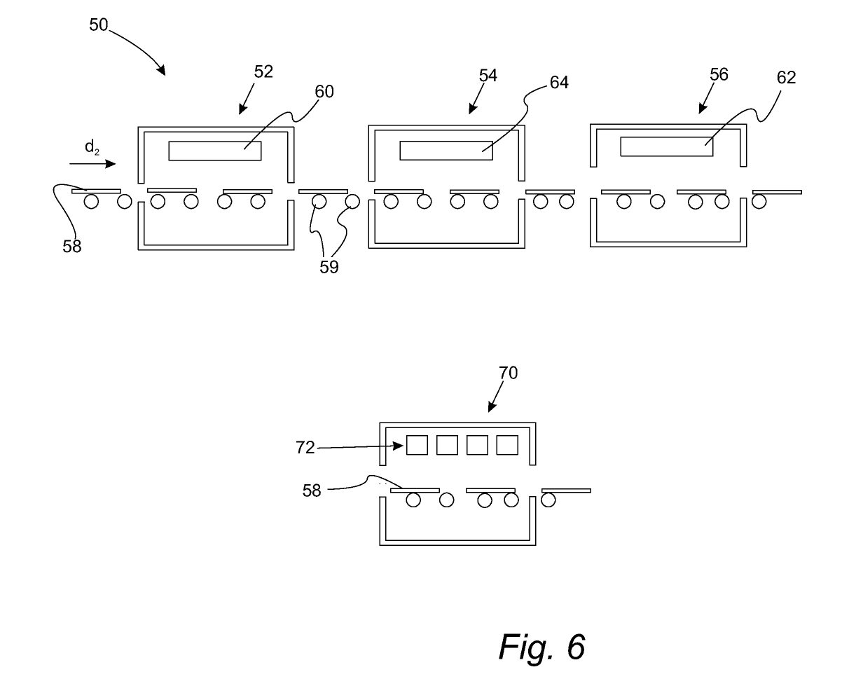

With reference to FIG. 6, a system for forming the coated substrates set forth above in connection with FIGS. 1-3 is provided. System 50 includes sputtering chamber 52, optional sputtering chamber 54, and sputtering chamber 56. In a particularly useful variation sputter chambers 52, 54, and 56 are magnetron sputtering systems. Such systems are commercially available from Leybold Optics GmbH and Applied Materials, Inc. Low or mid iron float glass substrates 58 are conveyed through system 50 via rollers 59.

Sputtering chamber 52 is used to deposit protective layer 18 onto substrate 12. For this purpose, sputtering target 60 is used. In one refinement, sputtering target 60 comprises silicon oxide and aluminum. Although precise depositions conditions for forming protective layer 18 are within those skilled in the art of sputter coating, sputter deposition at pressures less that 10 mTorr (e.g., 4 mTorr) and at powers of about 100 KW (e.g., 90 kilowatts) are typically satisfactory. Moreover, a silicon target containing about 17 weight percent aluminum (e.g., 126 inch long rotatable target with a source to substrate 5 inches) has been used. Sputter chamber 56 is used to deposit electrically conductive layer 20 over protective layer 18. For this purpose, sputtering target(s) 62 is used. In one refinement, sputtering target(s) 62 include that targets that are well-known by those skilled in the art for depositing transparent conductive oxides. Sputter chamber 54 is optionally used to deposit sodium barrier 40 over protective layer 18. For this purpose, sputtering target(s) 64 is used. In one refinement, sputtering target(s) 64 include that targets that are well-known by those skilled in the art for depositing metal oxide layers that are known sodium barriers.

Still referring to FIG. 6, system 50 also includes heat treatment chamber 70 for heat treating the coated substrates. In one refinement, heat treatment chamber 70 is downstream of the sputter coaters. In another refinement, heat treatment chamber 70 is a separate stand-alone unit. Heat treatment chamber 70 is equipped with one or more heaters 72. Examples of useful heaters include, but are not limited to, ceramic heaters, flash lamps, infrared and the like. In one refinement, the coated low or mid iron float glass substrates are heated under conditions that simulate tempering. For example, the coated glass substrates are heated to a temperature of at least 640° C. and then rapidly cooled down. Typically, during such simulated tempering, the coated low or mid iron float glass substrates reside in the tempering furnace for 1 to 3 minutes.

The following examples illustrate the various embodiments of the present invention. Those skilled in the art will recognize many variations that are within the spirit of the present invention and scope of the claims.

Low or mid iron float glass substrates are coated with electrically conductive aluminum doped zinc oxide (“AZO”) in order to compare the properties of such TCOs with and without a sodium accumulation layer. All the layers in these examples are formed by sputtering. The glass substrates are coated in continuous multi-position vacuum magnetron sputter coater magnetron. In each coating position, a 126 inch long rotatable target with a source to substrate distance of about 5 inches is used. The deposition pressures are about 4 mTorr. The thickness of the AZO layers are about 6000 angstroms and the thickness of the silicon oxide/aluminum oxide layers are about 350 angstroms.

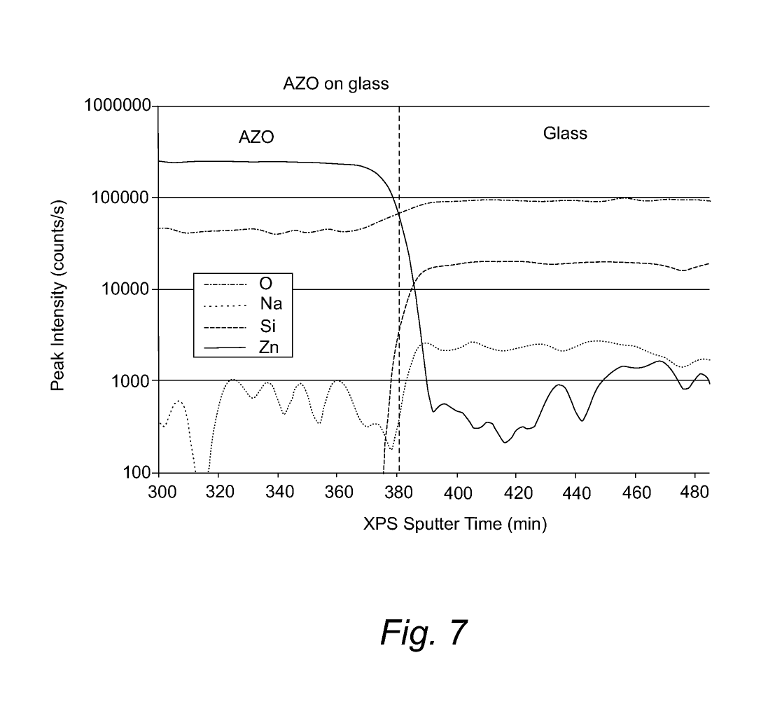

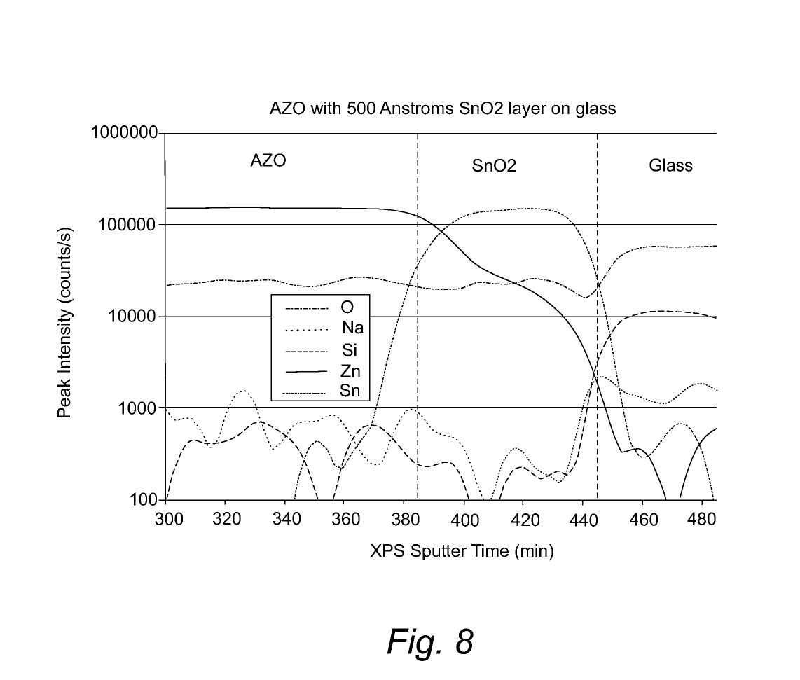

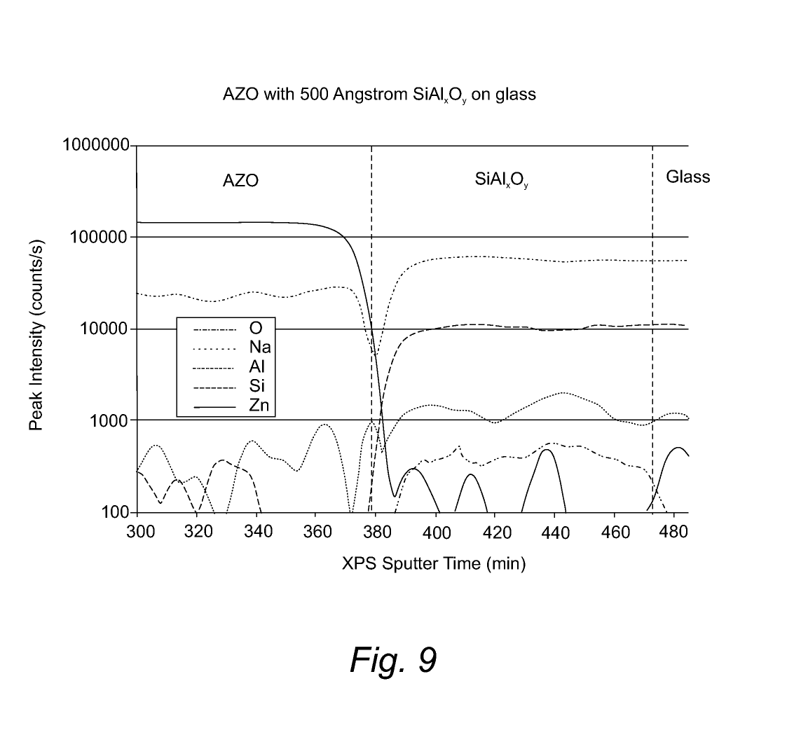

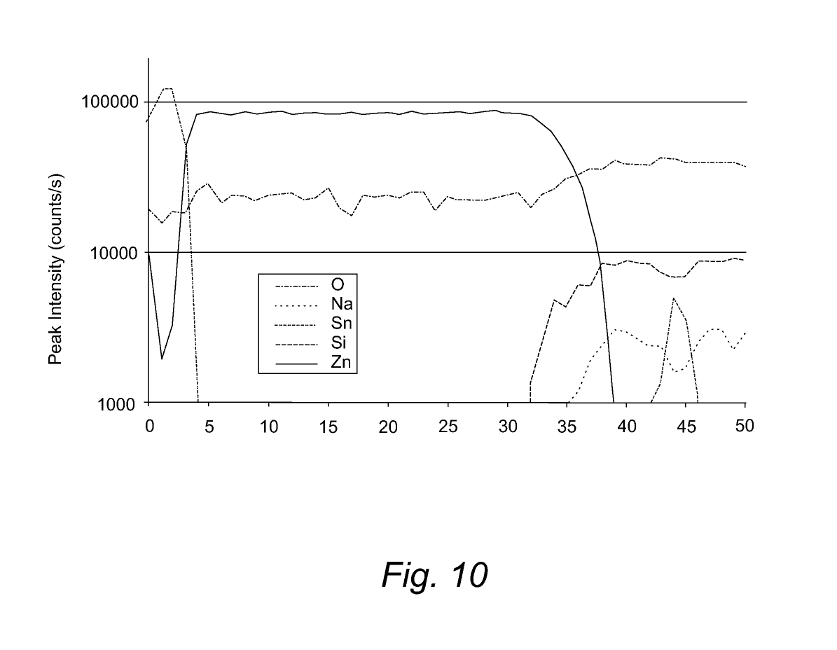

With reference to FIGS. 7, 8, 9, and 10, X-ray photoelectron spectroscopy (“XPS”) results are provided. In these plots, the counts per second for sodium, oxygen, silicon, zinc, aluminum, and tin atoms is plotted as a function of sputtering time to give a depth profile of the amounts of these atoms in a coated substrate. FIG. 7 provides an XPS plot for a glass substrate coated with a single AZO layer. Although such a coated substrate is known to be undesirable for device applications, sodium penetration into the AZO layer is readily observed. FIG. 8 provides an XPS plot for a glass substrate coated with a tin oxide and then an AZO layer. Tin oxide is a known efficient sodium barrier. In this figure, the amount of sodium at the glass/tin oxide interface is observed to peak, with amounts of sodium with the tin oxide layer being very low. This observation of sodium accumulating at the glass/tin oxide layer resulting in delamination during heat treatment. FIG. 9 provides an XPS plot for a glass substrate coated with a silicon oxide/aluminum oxide layer and then an AZO layer. Sodium is observed to penetrate and accumulate in the silicon oxide/aluminum oxide layer. Coated substrates which include a silicon oxide/aluminum oxide layer do not delaminate or delaminate with a lower frequency than coated substrates utilizing a conventional sodium barrier when heat treated and biased. FIG. 10 provides an XPS plot for a glass substrate coated with a tin oxide layer, a silicon oxide/aluminum oxide layer and then an AZO layer. In this example, 150 angstroms of tin oxide are coated onto a glass substrate which is then coated with 350 angstroms of a silicon oxide/aluminum oxide layer. Finally, 6000 angstroms of AZO are coated over the silicon oxide/aluminum oxide layer. The tin oxide is observed to be sufficiently thin that sodium in not blocked and instead accumulates in the silicon oxide/aluminum oxide layer.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A coated substrate for electrical or optical devices, the coated substrate comprising:
a transparent sodium-containing substrate;
a protective layer disposed over the substrate, the protective layer comprising aluminum oxides and silicon oxides and having a thickness of at least 400 angstroms; and
an electrically conductive layer disposed over the protective layer.

2. The coated substrate of claim 1 wherein the protective layer include from about 2 to about 50 weight percent aluminum oxides and about 98 to about 50 percent silicon oxides.

3. The coated substrate of claim 1 wherein the electrically conductive layer is transparent at visible wavelengths of light.

4. The coated substrate of claim 1 further comprising a high index layer interposed between the transparent sodium-containing substrate and the protective layer, the high index layer having a refractive index that is higher than the refractive index of the protective layer and a thickness less or equal to 200 angstroms.

5. The coated substrate of claim 1 wherein the electrically conductive layer comprises a component selected from the group consisting of tin oxide, doped tin oxide, indium tin oxide, zinc oxide, doped zinc oxide, and combination thereof.

6. The coated substrate of claim 1 wherein the electrically conductive layer is a metal.

7. The coated substrate of claim 1 wherein the electrically conductive layer comprises a component selected from the group consisting of aluminum, silver, stainless steel, molybdenum, copper, and combination thereof.

8. The coated substrate of claim 1 wherein the protective layer has a thickness from about 600 to 2000 angstroms.

9. A coated substrate for electrical or optical devices, the coated substrate comprising:
a transparent sodium containing substrate;
a protective layer disposed over the substrate, the protective layer comprising sodium, aluminum oxides and silicon oxides and having a thickness of from about 400 to about 2000 angstroms; and
an electrically conductive layer disposed over the protective layer.

10. The coated substrate of claim 9 wherein the electrically conductive layer is transparent at visible wavelengths of light.

11. The coated substrate of claim 9 further comprising a high index layer interposed between the transparent sodium-containing substrate and the protective layer, the high index layer having a refractive index that is higher than the refractive index of the protective layer and a thickness less or equal to 200 angstroms.

12. The coated substrate of claim 9 wherein the electrically conductive layer comprises a component selected from the group consisting of tin oxide, doped tin oxide, indium tin oxide, zinc oxide, doped zinc oxide, and combination thereof.

13. The coated substrate of claim 9 wherein the electrically conductive layer is a metal.

14. The coated substrate of claim 9 wherein the electrically conductive layer comprises a component selected from the group consisting of aluminum, silver, stainless steel, molybdenum, copper, and combination thereof.

15. The coated substrate of claim 9 wherein the sodium is present in an amount from about 1 to 15 weight percent.

16. A device comprising:
a coated substrate comprising:
a transparent sodium containing substrate;
a protective layer disposed over the substrate, the protective layer comprising aluminum oxides and silicon oxides and having a thickness from about 400 to 2000 angstroms; and
an electrically conductive layer disposed over the protective layer.
at least one electrically active layer disposed over the coated substrate.

17. The device of claim 16 wherein the electrically active layer comprises amorphous silicon.

18. The device of claim 16 wherein the coated substrate further comprises a high index layer interposed between the transparent sodium-containing substrate and the protective layer, the high index layer having a refractive index that is higher than the refractive index of the protective layer and a thickness less or equal to 200 angstroms.

19. The device of claim 16 wherein the electrically active layer comprises CdTe.

20. The device of claim 16 wherein the electrically active layer comprises copper indium gallium selenide.

21. The device of claim 16 wherein the protective layer include from about 2 to about 40 weight percent aluminum oxides and about 98 to about 60 percent silicon oxides.

22. The device of claim 16 wherein the electrically conductive layer is transparent at visible wavelengths of light.

23. The device of claim 22 wherein the electrically conductive layer comprises a component selected from the group consisting of tin oxide, doped tin oxide, indium tin oxide, zinc oxide, doped zinc oxide, and combination thereof.

24. The device of claim 16 wherein the electrically conductive layer is a metal.
